(19) United States
(12) Patent Application Publication
(10) Pub. No.: US 2003/0088516 A1
(43) Pub. Date: May 8, 2003

(54) SOFTWARE ANTI-PIRACY LICENSING

(76) Inventors: ERIC B. REMER, AMERICAN FORK, UT (US); DAVID A. KING, HIGHLAND, UT (US); DAVID L. REMER, OREM, UT (US); JOHN C. ALLEN, PLEASANT GROVE, UT (US)

Correspondence Address: DONNA JO CONINGSBY, BLAKELY SOKOLOFF TAYLOR & ZAFMAN LLP, 12400 WILSHIRE BOULEVARD 7TH FLOOR, LOS ANGELES, CA, 90025

(21) Appl. No.: 09/468,611

(22) Filed: Dec. 21, 1999

(51) Int. Cl. G06F 17/60

(52) U.S. Cl. 705/59

(57) ABSTRACT

A method for electronic enforcement of licenses for software services installed on computers connected through a communications network employs a non-renewable electronic license that is uniquely identified with a specific computer, is of limited duration, and is digitally signed to detect tampering. The licenses are maintained on the computer that operates the licensed software service, referred to as the point-of-service computer. The method employs intelligent license servicing agents to periodically refresh the limited duration licenses on the point-of-service computer with new purchased limited duration licenses from a license server. The license servicing agent pushes the licenses to or back from the license server. If necessary, the license servicing agent can operate on one or more console computers that act as proxy license servers by keeping a copy of the point-of-service licenses and refreshing them automatically when the license servicing agent initiates a connection to the point-of-service computer for maintenance. The licensing service agents can operate on any number of console computers or on the license server itself, and can operate to refresh licenses for any number of point-of-service computers. The point-of-service computers can operate independently of and without connection to the console computers or license server computers, and are automatically refreshed with new licenses without requiring end user intervention.

### BACKGROUND OF THE INVENTION

1. Field of the Invention

The present invention relates to electronic enforcement of licenses for software services installed for a predetermined time on computers connected through a communications network.

2. Background Art

Software piracy is a major problem for the software industry. An independent study released by the Business Software Alliance and the Software & Information Industry Association estimated that, of the 615 million new business software applications installed worldwide during 1998, 231 million were pirated. This represents a loss of over one-third of the licensing revenue that should have been generated, or nearly $11 billion dollars in 1998 alone. SIIA's Report on Global Software Piracy 1999, page 3, May 25, 1999 (Software & Information Industry Association, 1730 M Street NW, Suite 700, Washington, D.C. 20036, http://www.siia.net/piracy/news/news.htm).

There have been numerous efforts to devise systems to electronically enforce the licensing of computer software. A commonly used prior art system is to require the end user to enter an authorization code at installation time. If the authorization code matches the code that is incorporated in the software, then the software is installed on the computer. If the authorization code does not match, then the software cannot be installed, thereby protecting the software from unauthorized use. A major drawback to this system is that it does not generate a unique license. There is nothing to prevent the end user from installing the same software on a different computer as long as the proper authorization code is entered. Thus, the end user can create an unlimited number of unauthorized copies of the software.

To overcome this drawback, some enforcement schemes generate a unique license that is specific to the computer on which the software is installed. If the software is copied to another computer, the software will not function because it is not authorized for that computer. However, this scheme can be cumbersome in a large networked computer environment where the computer configurations are constantly changing to meet business needs.

Another commonly used prior art system requires the use of a read/write medium, such as a floppy disk, where the license is transferred from the medium to the installation target. This, too, can be a cumbersome licensing scheme since it requires a transfer medium. Moreover, there is nothing to prevent an end user from transferring the license back to the medium and installing it on another unauthorized computer.

The current trend in software procurement is to eliminate the physical medium altogether. With the advent of the internet, an increasing number of software applications are distributed electronically. While the internet has accelerated software piracy, it has also provided software vendors with new opportunities for electronic license enforcement. Electronic software distributors can generate a one-shot temporary electronic license that is downloaded with the software to allow the end user to install the software on their computer for a limited duration trial period. After the expiration of the temporary electronic license the end user must purchase a full license, or the software is disabled.

A problem with these so-called “try and buy” electronic licensing schemes is that they are designed for direct software sales to end users in stand-alone computer environments. They require the end user to connect directly to the distributor's electronic commerce web site to purchase a single license. Many of them have the same disadvantages associated with more conventional electronic licensing schemes, since they often require the use of an authorization code. The only difference is that the authorization code is delivered to the user electronically, typically only after the user has registered with the web site. There is still no way to insure the authorized use of the software once it has been electronically distributed. Most importantly, the prior art electronic licensing distribution and enforcement schemes are not designed for multi-computer networked environments requiring a high volume of multiple licenses. License enforcement schemes designed for the stand-alone computer environment may not work properly in a multi-computer networked environment.

Another disadvantage to prior art electronic enforcement schemes is that they lack the ability to allow for the periodic electronic renewal of a temporary license for subscription-based software services. Instead, the prior art enforcement schemes are based on the assumption that the software license is purchased outright, and not renewed for limited periods of time.

Reported industry trends indicate that electronic license distribution will be the corporate standard within the next decade. It is anticipated that electronically distributed licenses will account for $89 billion dollars of revenue for the software industry by the year 2001. Computerworld, Electronic Licensing Gains in Popularity, David Orenstein, Oct. 19, 1998, p.65(1). Therefore, the electronic enforcement of software licenses is a critical component of the software anti-piracy effort. Accordingly, a new approach to electronically enforcing software licenses that is flexible and scalable, but not unnecessarily burdensome for legitimate end users, is desirable.

### SUMMARY OF THE INVENTION

A licensing service is provided with an enforcement agent to control the licensing for an installed software on a device. The licensing service further provides a license issuer to issue licenses for the installed software, and a service agent, in communication with the enforcement agent and the license issuer, to distribute licenses from the license issuer to the device.

### BRIEF DESCRIPTION OF THE DRAWINGS

Further advantages and features of the invention will become apparent in the following detailed description and accompanying drawings.

FIG. 1 illustrates an example of a typical computer configuration for an implementation of the method of electronic license enforcement.

FIG. 2 is a flow diagram illustrating an implementation of the general flow of license generation and distribution.

FIGS. 3A and 3B are flow diagrams illustrating an exemplary interaction between a Point-of-Service computer (POS) as shown in FIG. 1, and a licensing service agent.

FIG. 4 is a flow diagram illustrating an exemplary interaction between a licensing service agent and a Value Added Reseller (VAR) as shown in FIG. 1.

### DETAILED DESCRIPTION

Overveiw

The following sections describe an improved method for electronically enforcing licenses for installed software services. The method can be implemented in a multi-computer networked environment having a variety of configurations, or on a single stand-alone computer. The goal of the method is to service the licensing needs of end users who have installed licensed software on their computers. The method not only insures license compliance, but does so in a manner that is transparent to the end user.

In the implementation the method employs a non-renewable license that is uniquely identified with a specific computer and is of limited duration. There are three types of licenses: install, trial, and purchased. All licenses are digitally signed to protect against tampering. A license is considered valid when it is present on the point-of-service (POS) computer where the software service is installed, when it has a valid digital signature, and when it is not expired.

In the implementation, the POS computers on which the software services are installed are self-licensing. The install and trial licenses originate at the POS, whereas the purchased licenses are issued by a third party. The third party is either a software vendor, a value added reseller of software services, or a corporate license server. Depending on the capabilities of the third party, in one implementation, a licensing service agent pushes licenses as they are generated on the POS up to the third party for eventual refreshing. In another implementation, the licensing service agent may need to periodically collects copies of the POS licenses (either new install or trial licenses, or expired purchased licenses) from one or more POS computers and exchange them in bulk for new purchased licenses. Regardless of the particular implementation, the exchange is referred to as a “Refresh Licenses” task. In one implementation, the “Refresh Licenses” task is performed by executing an electronic commerce transaction with the third party over the internet. Alternatively, it may be performed over a private network using other known means of electronic data interchange.

The service agent periodically pushes the refreshed licenses back to the POS computers with which they are uniquely identified, so that the licenses themselves are always maintained on their respective POS computer. If the software service is later removed from the POS, the license is allowed to remain. Since the license is uniquely identified to a specific POS, it cannot be transferred.

Because the POS is self-licensing, any number of service agents can purchase licenses for any given POS computer with which the service agent can connect via a local or remote network. In an implementation of the method, the service agent may reside on one or more service management consoles. The consoles themselves are not licensed, but rather provide the conduit through which the licenses flow between the POS and the third party. The service agent maintains copies of collected POS licenses and new purchased licenses issued by the third party in a discovery database. The service agent synchronizes the collection of licenses from POS as well as the replacement of the POS licenses with new licenses using the discovery database

The relationships between the various POS computers serviced by the service agent may be graphically displayed as a node tree to facilitate the bulk administration and purchase of new licenses. In an implementation of the method, the “Refresh Licenses” task is accomplished at the level of the root node of the tree. The interaction between the service agent and the third party can be implemented over a network such as the internet by the exchange of a license file using standard communication protocols. At least two levels of service agent/third party interaction are provided; administrator level interaction and technician level. In addition to refreshing licenses, the service agent also performs other system maintenance and alert functions for the POS computers.

Detailed Operation

The licensing functions that the method of the invention performs are logically broken down into two types: those that are performed on the end user's computer, and those that are performed elsewhere. As a point of reference, the end user computer is the logical starting point, because that is where the first license originates. When the software is initially installed on the end user computer, it generates its own license, called an install license. For descriptive purposes, this end user computer is referred to as the “point-of-service,” or POS.

The POS install license is set to expire immediately. Its main purpose is to be used to generate a trial license. In one implementation, the POS install license is stored in a common location in the computer, such as the Pong Data. The Pong Data is periodically “pinged” by an external license servicing agent to retrieve the license for processing. In another implementation, the POS will initiate contact with an external licensing service to obtain a license. The first step in license processing is to generate the trial license. The trial license is generated on the POS by an internal software agent that resides on the POS. The trial license generation may be triggered by the external agent by “pinging” the Pong Data. Alternatively, it could be triggered by the POS itself; either way the trial license replaces the install license and is stored on the POS. The install license begins a licensing cycle that is repeated for as long as necessary to insure that the POS has a current license. The trial license allows the end user to “test drive” the software service for a predetermined amount of time. When the trial license expires, the external license servicing agent delivers a new purchased license assuming that the end user has made the proper payment arrangements. The POS conditionally replaces the expired license with the new license without end user intervention. Conditions that must be satisfied to successfully replace a license include authenticating the new license, and insuring that it has not expired. Like the trial license, the purchased license is of limited duration, and will eventually need replacement. Because the licenses themselves are maintained on the POS computers, the method is scalable to service a large number of end users.

The POS performs a number of other functions, besides coordinating the generation and replacement of the install, trial, and purchased licenses. Each time the software service is used, the POS performs a verification function to insure that the current license is valid. The verification process is based on an authentication model that uses the license to verify that the POS is authorized to use the licensed software service at the present time. To facilitate this process, the method uses a license format that contains a unique identifier that associates the license with a specific POS computer. In addition, the license format includes a digital signature that incorporates information from the unique identifier, as well as the rest of the license information (e.g. creation time and expiration).

The license's digital signature is created using encryption technology that is known in the art. Because the digital signature depends on the content of the license, the license's digital signature changes each time a new license is generated. The digital signature enables the POS to determine whether a given license is authentic (i.e. was either generated by the POS itself, or issued by an authorized license server) and to verify the integrity of the license (i.e. detect whether any of the information in the license has been tampered with, e.g. creation time, expiration time).

The digital signature depends in part on the value of the license's unique identifier. The unique identifier is a globally unique identifier (GUID) that insures that the license will only authorize use of the installed software for that particular POS and no other. For descriptive purposes, the unique identifier is called a Node ID, referring to the POS in the context of the network in which it resides. However, the POS may, in fact, be a stand-alone computer as well. In the stand-alone context, the Node ID is a unique identifier that will distinguish the POS from other POS computers that are serviced by the same external license distribution agent or whose licenses are issued by the same license server.

The external license servicing agent that initiates contact with or responds to the POS may take many forms. For example, in some implementations it may take the form of a software agent that resides on a vendor's electronic commerce web site that services various individual end users needing to license a variety of software services for their stand alone or local area networked computers. In larger corporate organizations, the external license servicing agent may be implemented in an application that resides on a license server computer that administers a high volume of licenses purchased on behalf of the end users from an outside vendor. The license server may reside within the corporate network, or may be part of network operated by a value added reseller (VAR). The license server can manage many POS computers, and so is equipped with additional features to enable the bulk administration of licenses, including bulk purchase and distribution.

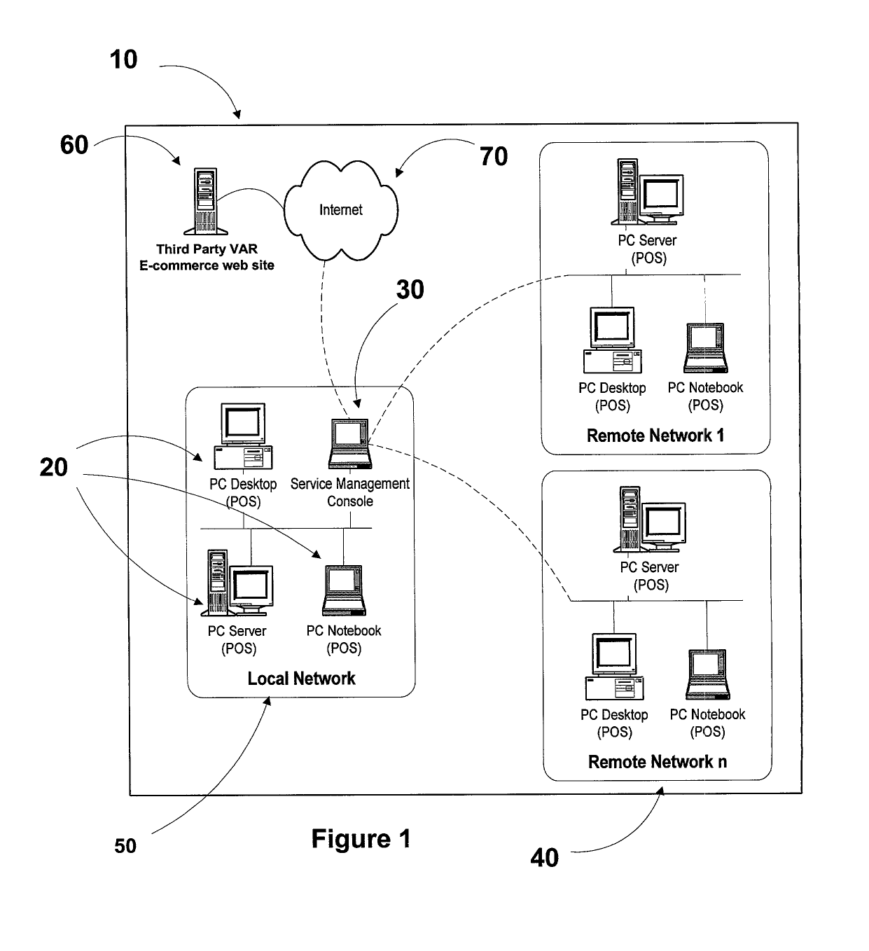

An example of a typical configuration (10) of a multi-computer networked environment in which the method can operate is illustrated in FIG. 1. With reference to FIG. 1, the end user computers on which the software services are installed are referred to as the point-of service (POS) computers (20), as previously described. They may be server computers, desktop computers, notebook computers, or any other computer where a licensed software service resides or is used. In any given configuration, there may be at least one service management console (30) that is connected to and services the POS computers (20) via a remote (40) or local area (50) network. The service management console (30) contains the external license servicing agent that services the POS computers (20). In the illustrated implementation, the service management console (30) acts as a proxy license server, retrieving existing licenses from the POS computers (20), and interacting with a third party vendor website (60) that issues new purchased licenses over a network such as the internet (70). The newly purchased licenses are in turn delivered by the external license servicing agent on the service management console (30) back to the POS computers (20) via the remote (40) or local area (50) network. For maximum flexibility, the external license servicing agent can be implemented in any number of service management consoles, or alternatively in the third party vendor's system. Another implementation might employ a different configuration or communicate with the third party using a private network without departing from the principles of the invention.

As previously noted, a goal of the method is to not only insure license compliance, but to do so in a manner that is transparent to the end user. The method accomplishes this by using a combination of intelligent software agents and the “push technology” model of computer interaction. Intelligent agents are application software programs that are designed to move logic and data over networks such as the Internet. They are typically used in electronic commerce applications to facilitate transactions between disparate computer systems. “Push technology” refers to the practice of delivering specific information directly to another electronic device or computer, eliminating the need for that other device or computer to request it. The implementation of the method uses an intelligent agent to locate and retrieve or send the license on the POS computer to a license server, and to replace the license by delivering a new one as necessary, without the end user's involvement.

Appropriate decisions about how to process the license can be shared between the external intelligent agent and the agent that resides on the POS. The decisions include determinations about whether or not the license is valid and whether or not it can be replaced. The determinations are made by examining the license's identity, authenticity, and expiration information. A license is considered valid when it is present on the POS, has a valid digital signature, and is not expired. A valid license authorizes a POS to operate the software service until the expiration date and time in the license. Once a license has expired it is invalid and requires a new license to replace it. A license can be replaced when there is a newer purchased license available that has the identical Node ID. A purchased license is one that has been generated by the third party vendor, or some other license issuer (e.g. a corporate license server, electronic software distributor, VAR, etc.). Licenses are non-renewable and non-transferable. Licenses remain on the POS indefinitely, even if the software service to which the license pertains is removed.

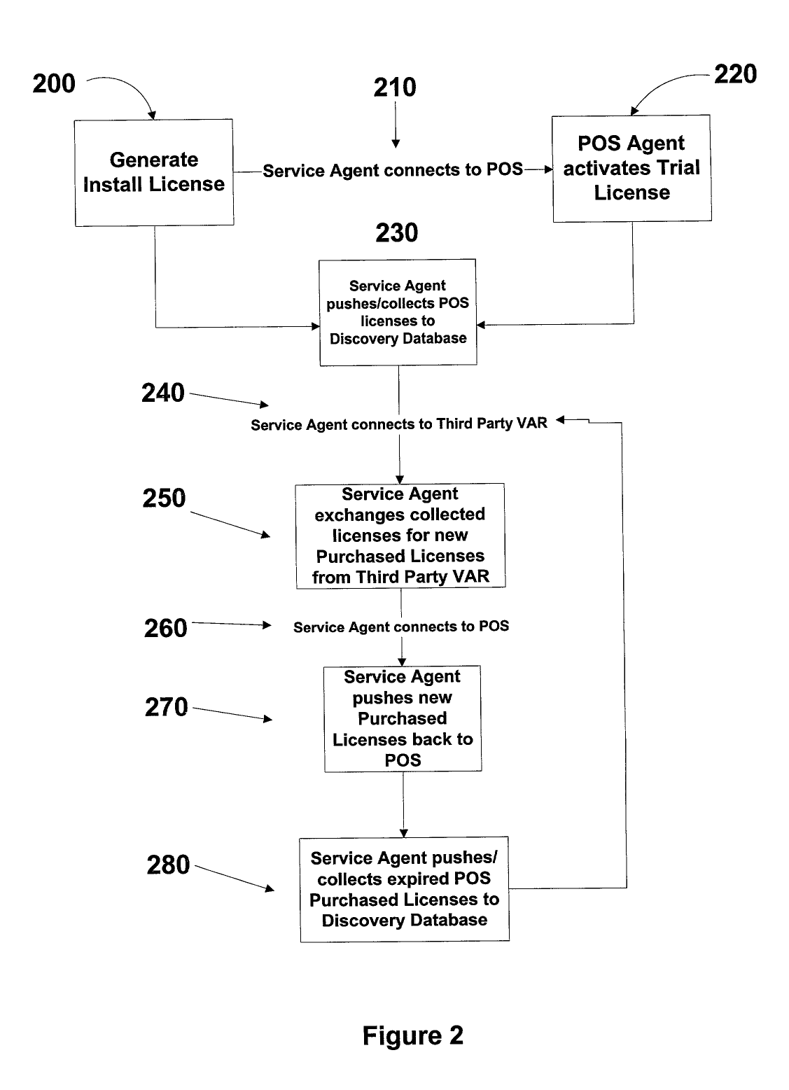

FIG. 2 illustrates the general flow of an implementation of the method of license generation. First the POS generates the install license (200). When a service management console connection is attempted (210), a software agent residing on the POS is triggered to create a trial license (220) using the previously generated install license. The trial license is set to expire at a predetermined date and time. The current POS license, whether it be an install, trial, or previously purchased license, is collected by the external license servicing agent to a discovery database that resides on the service management console (230). In the illustrated implementation, after collecting licenses from one or more POS computers, the external license servicing agent initiates a connection from the service management console (230) to a third party VAR, an electronic commerce site that will issue purchased licenses for the software services installed on the POS computers (240). The external license servicing agent exchanges the licenses on the discovery database (280) in the service management console that were collected from the POS computers for new purchased licenses issued by the VAR (250). Subsequently, the external license servicing agent initiates a connection from the service management console to the POS computer (260) to push the new purchased licenses back to the POS (270). The external license servicing agent continues the cycle by periodically retrieving and collecting expired POS licenses to the discovery database (280) on the service management console, and again connecting from the service management console to the VAR to refresh the licenses (240).

The following structure in Table 1 defines an implementation of the license:

TABLE 1
struct_LICENSE {

| | |
|---|---|
| uint8 | signature [16]; |
| uint16 | version; |
| uint8 | flags; |
| uint8 | osType; |
| uint32 | reserved; |
| time_t | creationTime; |
| time_t | expirationTime; |
| uint8 | nodeID[16]; |

}

The specific structure of the license may vary without departing from the principles of the invention. A detailed explanation of each field in the license structure follows:

Signature. This field represents a digital signature that is used to validate the license. One implementation of the digital signature is generated by applying the MD5 message digest algorithm to the structure starting at the version field and continuing until the end of the structure (only the length and signature fields are omitted) (Request For Comment 1321, R. Rivest, MIT Laboratory for Computer Science and RSA Data Security, Inc., April 1992) The resulting message digest is encrypted with a 56-bit DES key extracted from the 128-bit node ID field (defined below).

Version. This field represents the license version number. The version number allows for future enhancements to be made to the license structure. One implementation of the version number starts with the number 1 and is monotonically incremented as the license definition is enhanced.

Flags. This field is comprised of eight bits. In the implementation, only the least significant bit is defined for license version 1. If set, it signifies that the license is either an Install or a Trial License. In particular, this bit is set to 1 if the license is created by the POS agent or the POS install, and is clear (set to 0) if the license is created by the third party web site. The bit is used to indicate the origin of the creation time field to make valid comparisons using that field. The third party web site never sets this bit.

OS Type. This field represents the type of operating system used on the POS computer. This field can take on one of the following values as shown in Table 2:

TABLE 2

| | |
|---|---|
| #define UNKNOWN | 0 |
| #define NTW4x | 1 |
| #define NTS4x | 2 |
| #define NW3x | 3 |
| #define NW4x | 4 |
| #define NW5x | 5 |
| #define WIN95 | 6 |
| #define WIN98 | 7 |

Creation Time. This field represents the date and time the license was created. Expiration Time. This field represents the expiration date and time. The Expiration Time is set to zero if this license is an Install License.

Node ID. Each POS is uniquely identified by a Node ID (also referred to as a globally unique identifier, or GUID). Node IDs are preserved across installations. The Node ID identifies the license as being associated with exactly one POS computer.

Component Detail

The functions performed by the method of the present invention may be implemented in three distinct components: the POS component, the Servicing component, and the VAR component. Each component is described in more detail below.

POS Component

The POS, also referred to as a managed node, generates the install license when the software service is initially installed. The POS sets the install license's Node ID to a globally unique identifier, or GUID, that is used to identify the license with that specific POS computer throughout the entire cycle of license servicing. The install license is always set to expire immediately. When a servicing agent of the Servicing component attempts its first connection to the POS, a software agent on the POS is triggered to generate a trial license that expires after a predetermined date and time. The POS embeds the current POS license in its PDS Pong Data. The Servicing component uses this mechanism to periodically retrieve licenses from the POS for collection to the Service component's discovery database. The POS license is never deleted from the POS computer, even if the software service to which it pertains is uninstalled. This preserves the Node ID and license period across installs.

Each POS must have a valid license in order to be able to use the software service. Since POS computers are self-licensed, any number of service agents can interact with any number of POS computers. All three of the following conditions must be true for a POS to have a valid license:

1) a license must be present on the POS,

2) the license's digital signature must be valid, and

3) the license expiration time must be later than the POS's current system clock.

The POS can continue operating autonomously even without a valid license. However, any servicing activity initiated by a service agent of the Servicing component is disabled until a new license is available.

Servicing Component

The Servicing component of the method of the present invention includes a service agent and a discovery database. The Servicing component may reside on a license server computer that is either maintained by the third party license reseller (e.g. on the VAR web site, or license server), or may reside on one or more service management consoles that are distributed throughout the network that connects the end user computers. The computers where the Servicing component resides are themselves not licensed. The Servicing component can interact with any POS that has a current valid license. Where the Servicing component resides on a service management console, the console acts as a proxy server, and provides the conduit through which licenses flow between the VAR web site and the POS computers.

The service agent maintains a discovery database of retrieved and collected licenses from the POS computers, and purchased licenses issued by the VAR web site. There can only be one license for each POS's unique Node ID at any given time. The service agent validates all licenses that it receives, and stores only valid licenses in the Servicing component discovery database.

The Servicing component is the focal point for any interaction with the VARs that issue the purchased licenses. The Servicing component may be administered by either an administrative level or technician level operator for the bulk purchase and distribution of licenses. The POS computers to which the Servicing component can connect are graphically displayed to the operator in the form of a node tree. The operator can display a POS's license expiration time as a property accessible when the corresponding node is selected in the tree. At the root node, the Servicing component provides the operator with a “Refresh Licenses” task. All Servicing interactions with the VAR web site are conducted through this single task.

The interaction between the POS and the Servicing components may be performed automatically, without operator intervention. When the POS license expires, any active POS servicing connection is dropped, and the following Servicing component functionality is disabled:

1) connecting to the POS without new license,

2) starting a remote control session, and

3) configuring alerts.

The following functionality is always operational, even when the POS does not have a valid license:

1) connecting to the POS with a new license,

2) discovery (retrieving and collecting expired licenses),

3) health connections and updates, and

4) alerting.

VAR Component

The VAR Component provides all billing related functionality, including the following:

1) register/authenticate Servicing component operators,

2) register new Node IDs designating new POS computers,

3) organize customers and related POS Node IDs,

4) purchase licenses, and

5) cancel licenses.

The primary function of the VAR, in the implementation of the method of the present invention, is to respond to the Servicing component initiated “Refresh Licenses” task by exchanging the existing license data on the Servicing component's discovery database with new license data issued by the VAR.

The “Refresh Licenses” task may be initiated by at least two different levels of Servicing component operators: an administrative level or a technician level. The method employed by the VAR must take into account the operator level in the operator authentication procedure. Otherwise, the VAR responses to the Servicing component “Refresh Licenses” task are essentially be the same. The Servicing component administrator is responsible for purchasing licenses and equipment, but not necessarily responsible for all small business management. The Servicing component technician is responsible for the management of any number of small businesses, but does not necessarily have authority to purchase licenses or equipment. Each technician might have a locally installed copy of the Servicing component, distinct from the administrator's and other technicians' Servicing components.

The VAR component is also responsible for properly distinguishing requests from different customers by authenticating the user name and password of the Console operator at time of connection.

POS/Servicing Component Interaction

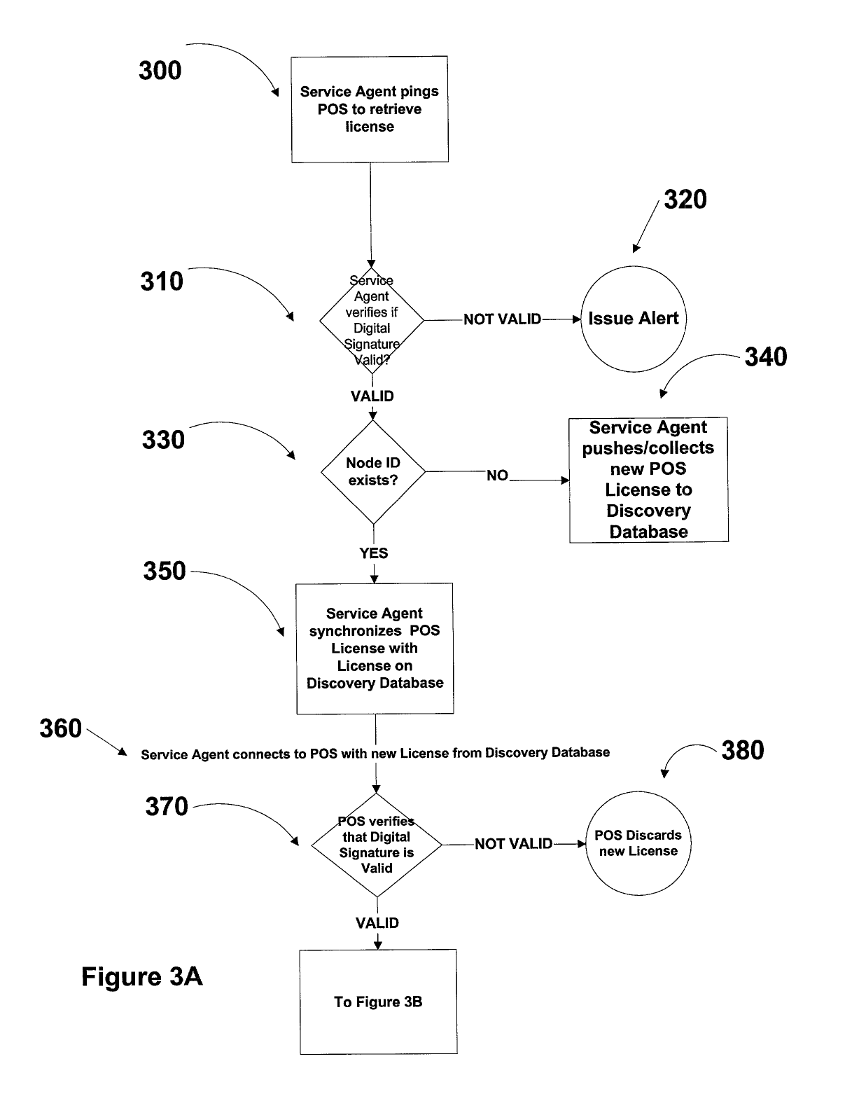

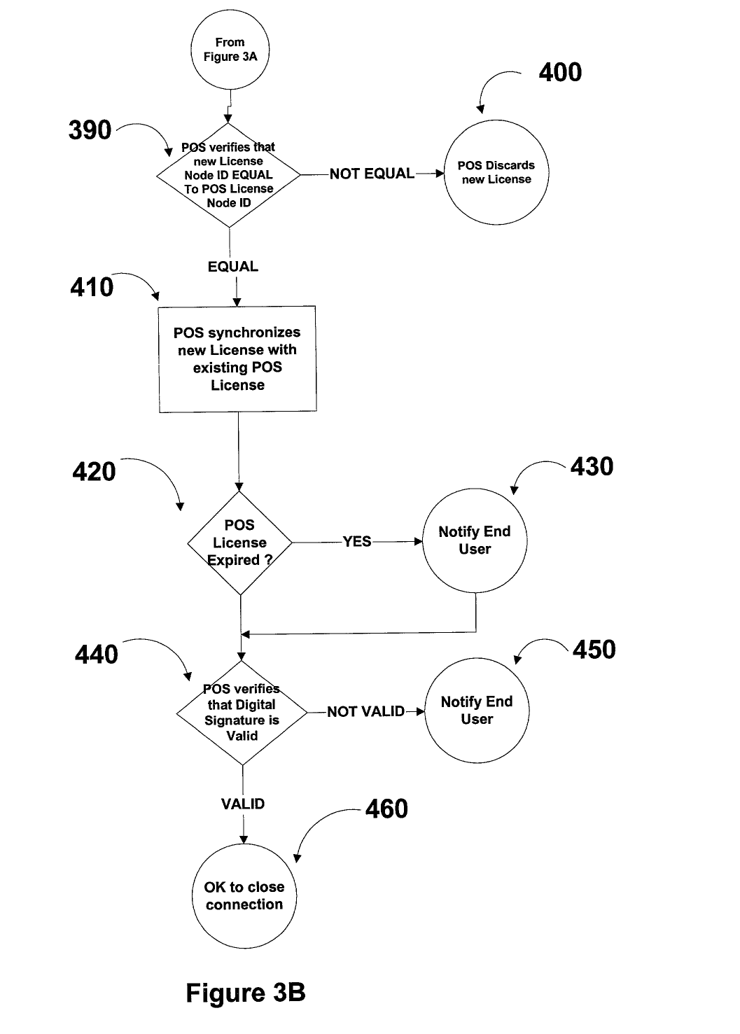

An example implementation of the interaction between the POS computer and the Servicing component is shown in FIGS. 3A and 3B. With reference to FIG. 3A, the service agent of the Servicing component initiates the interaction by pinging the POS computer from a service management console to retrieve the current POS license plus other connection information from the PDS Pong Data (300). The service agent first verifies that the digital signature of the retrieved POS license is valid (310). If so, the service agent compares the Node ID field of the current POS license with the Node ID of the existing license in the discovery database (330). If the Node IDs are different, then this must be a new POS license that has not yet been collected to the discovery database. The service agent collects a copy of the new POS license into the Servicing component's discovery database (340). Otherwise, if there is an existing license with the same Node ID, the service agent must synchronize the retrieved POS license with the existing license on the discovery database (350). If the digital signature of the POS license was not valid, then the service agent issues an alert (320).

The service agent requests a connection with the POS (360). The corresponding license from the discovery database is included in the request. In response to the connection, the POS first verifies that the digital signature of the license from the discovery database is valid (370). It not, the POS discards the discovery database license (380).

With reference to FIG. 3B, if the digital signature is valid, the POS compares the Node ID field of the discovery database license with the POS's current license (390). If the Node IDs are different, then the POS simply discards the discovery database license (400) as it does not belong to this POS. If the Node Ids are the same, the POS must synchronize the discovery database license with the POS's current license (410).

After synchronization, but before terminating the connection, the POS must now verify that it has a current valid license to operate the installed software service. The POS first verifies whether the license has actually expired (420). This might be the case if there was no newer license on the discovery database to replace the PO's old license. If so, then the end user (430) is notified. The POS then verifies that the digital signature of the current POS license is valid (440). If it is not valid, then the end user (450) is again notified. In this case, the license has likely been tampered with or is missing, and the POS will require a reinstall of the software service. Another possible error is that the license version is unknown, however this is unlikely to occur. If the POS verifies that it has a current valid license, the connection with the service agent is successfully terminated (460).

In order for the service agent and the POS to properly synchronize the discovery database license with the POS license, the decision table in Table 3 is used. The decision table specifies under which conditions the service agent and the POS should update their respective licenses with a new license received from another source (i.e. the VAR, or other license server). The New License and Existing License columns in Table 3 refer to the values of bit zero of the Flags field within the license. As described previously, if bit zero is set (equals 1), then the license was created by the POS install or the POS agent at the time of Console connection. These licenses are referred to as install licenses or a trial licenses, respectively. If bit zero is clear (equals 0), then the license is a purchased license created by the VAR web site.

The service agent and the POS synchronize their respective discovery database and POS licenses by determining whether a new license from each other is, in fact, newer, by comparing the corresponding Creation Time fields.

TABLE 3

| New | Existing | Service Agent | POS |
|---|---|---|---|
| License | License | Updates? | Updates? |
| 0 | 0 | If newer | If newer |
| 0 | 1 | Always | Always |
| 1 | 0 | Never | Never |
| 1 | 1 | Always | Never |

(where 0 = purchased, 1 = install/trial)

As can be seen, the decision table in Table 3 indicates that a purchased license always overwrites an install or trial license, while the reverse is never allowed. The Creation Time field is only trusted when both licenses were purchased, because they originated from the VAR web site (or license server), which is assumed to have a reliable clock.

Servicing Component/VAR Interaction

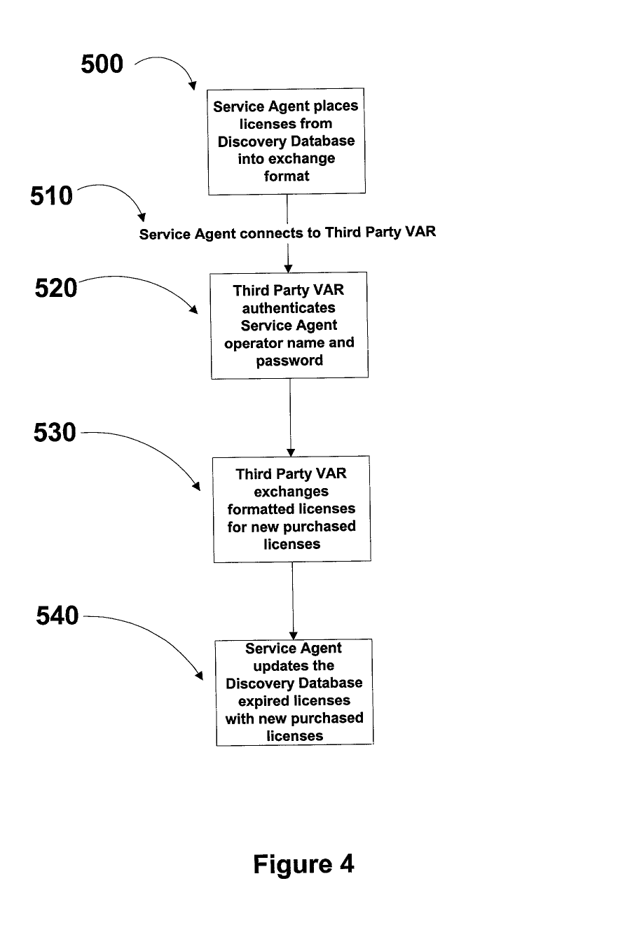

The Serving component and the VAR web site interact through the “Refresh Licenses” Task. With reference to FIG. 4, in preparation for initiating a connection to the VAR to purchase new licenses or receive updated licenses, the service agent places the collected and synchronized licenses on the Servicing component discovery database into an exchange format that is compatible with that used by the VAR (500). The service agent then connects to the third party VAR (510), upon which the VAR authenticates the Servicing component operator user name and password as entered into the Refresh Licenses task (520). The VAR then simply exchanges the service agents's exchange-formatted licenses for new purchased licenses (530). In turn, the service agent updates the expired licenses on the Servicing component discovery database with the new purchased licenses from the VAR (540).

Example Implementation

The exchange of licenses may be accomplished in a number of ways. In one example implementation of the method, the exchange is accomplished by formatting an exchange license file that is in well-formed, non-validated XML described by the following DTD:

<!ELEMENT licenses (license)*>
<!ATTLIST licenses

version CDATA #REQUIRED
created CDATA #REQUIRED>

<!ELEMENT license (EMPTY)>
<!ATTLIST license

customer CDATA #IMPLIED
node CDATA #IMPLIED
value CDATA #REQUIRED>

An example of such a license file is illustrated below:

<?xml

version=“1.0”
encoding=“UTF-8”?>

<LICENSES

version=“1.0”
created=“12/1/98”>

<LICENSE

customer=“My Business”
node =“TERMINUS”
value=“rqYfjgS1lMGepaimCp2QKQEAAAEAAAAAn91i
NvIQ3zZylcVa3n/SEY8GAKDJMYZr”/>

</LICENSES>

The text of the LICENSE value attribute shown in the above example is a base-64 encoding of the binary license structure shown in Table 1.

In the example implementation, the “Refresh Licenses” task performs the following functions:

1) The service agent places all licenses in the discovery database in the XML format described above.

2) The service agent sends the XML data to the VAR web site, using the HTTP POST operation to a well-known URL. The Servicing component operator's credentials are placed in the HTTP header.

Basic Authentication is used to verify the operator's name and password.

3) The third party VAR web site (or other license server) places the new purchased license data in the body of the HTTP response message following the same XML DTD described above.

4) The service agent parses the downloaded purchased license data and updates all corresponding expired licenses in the Servicing component discovery database.

While the method is implemented in software program modules, it can also be implemented in digital hardware logic or in a combination of hardware and software components. In view of the many possible implementations to which the principles of our invention may be applied, we emphasize that the implementations described above are only examples of the invention and should not be taken as a limitation on the scope of the invention. Rather, the scope of the invention is defined by the following claims. We therefore claim as our invention all that comes within the scope and spirit of these claims.

We claim:

1. A method for licensing software comprising:
generating on a first computer a first license for software installed on the first computer,
generating on a second computer a second license for the installed software,
obtaining from the second computer the second license as authorized by the second computer,
conditionally replacing the first license with the second license,
periodically repeating the obtaining and replacing so that the first computer remains licensed.

2. The method of claim 1, wherein the first and second licenses each share a unique identifier, the unique identifier associating the first and second licenses with the first computer.

3. The method of claim 1, wherein the first and second licenses are digitally signed.

4. The method of claim 1, wherein obtaining further comprises:
connecting to the second computer,
providing the second computer with at least some or all of the data from the first license, and
exchanging the provided data from the first license for the second license.

5. The method of claim 4, wherein connecting to the second computer is performed using a communications network.

6. The method of claim 5, wherein the communications network is the internet.

7. The method of claim 5 wherein exchanging includes formatting the data from the first license using XML and exchanging the formatted data using the HTTP protocol.

8. The method of claim 2, wherein conditionally replacing further comprises:
matching the unique identifier of the second license to the unique identifier of the first license, and if not matched discarding the second license without replacing the first license, and
authenticating the digital signature of the second license, and if not authentic discarding the second license without replacing the first license.

9. The method of claim 1, further comprising verifying whether the replaced license is valid, including determining whether the replaced license has expired.

10. The method of claim 3 wherein digitally signed includes applying a message digest algorithm to a portion of the license not including a length of the license or the digital signature, resulting in a message digest, the message digest being further encrypted with a binary key extracted from the unique identifier.

11. A licensing service comprising:
an enforcement agent to control the licensing for an installed software on a device,
a license issuer to issue licenses for the installed software,
an service agent, in communication with the enforcement agent and the license issuer, to distribute licenses from the license issuer to the device.

12. A license provider comprising:
a license authorizer to authorize the issue of licenses for software installed on remote devices,
a license issuer to issue the authorized licenses,
a license distributor to distribute the issued authorized licenses to the remote devices,
a license enforcer to prevent the operation of the installed software on the remote device without an authorized license.

13. A computer-readable medium having computer-executable instructions for performing:
generating on a first computer a first license for software installed on the first computer,
generating on a second computer a second license for the installed software,
obtaining from the second computer the second license as authorized by the second computer,
conditionally replacing the first license with the second license,
periodically repeating the obtaining and replacing so that the first computer remains licensed.
